(19) United States
(12) Patent Application Publication
(10) Pub. No.: US 2024/0118219 A1
(43) Pub. Date: Apr. 11, 2024

(54) INSPECTION APPARATUS AND INSPECTION SYSTEM

(71) Applicant: FUJIFILM Business Innovation Corp., Tokyo (JP)

(72) Inventors: Kiyofumi AIKAWA, Kanagawa (JP); Kaito TASAKI, Kanagawa (JP); Yoshitaka KUWADA, Kanagawa (JP)

(73) Assignee: FUJIFILM Business Innovation Corp., Tokyo (JP)

(21) Appl. No.: 18/353,203

(22) Filed: Jul. 17, 2023

(30) Foreign Application Priority Data
Oct. 6, 2022 (JP) 2022-161369

(51) Int. Cl. G01N 21/896

(52) U.S. Cl. CPC G01N 21/896; G01N 2021/8965

(57) ABSTRACT

An inspection apparatus includes a limiting unit that is provided between a light source and a target region and limits light traveling from the light source toward the target region, and an imaging unit that captures an image using light passing through the limiting unit, reflected from the target region, and incident on the imaging unit. The limiting unit allows light, which travels in one direction and is incident on the imaging unit in a case where the light is specularly reflected from the target region, to pass and allows at least a part of light, which travels in other directions, not to pass, among light emitted from the light source.

### CROSS-REFERENCE TO RELATED APPLICATIONS

This application is based on and claims priority under 35 USC 119 from Japanese Patent Application No. 2022-161369 filed Oct. 6, 2022.

### BACKGROUND

### (i) Technical Field

The present invention relates to an inspection apparatus and an inspection system.

### (ii) Related Art

JP2010-190597A discloses an appearance inspection apparatus that generates a radiation angle illumination region on the surface of an object to be inspected by a blocking plate, which is disposed on an optical path between a light source and the object to be inspected and blocks main emitted light, and images the radiation angle illumination region with a camera to detect unevenness defects formed on the surface decorated with a pattern.

JP2001-050720A discloses a surface inspection apparatus that blocks a part of reflected light according to a change in a reflection angle on the surface of an inspection target and identifies a surface state of the inspection target depending on a change in the amount of light, in a case where reflected light reflected from the inspection target is received by a light receiving unit.

JP2009-074815A discloses a lens defect inspection apparatus including: an illumination unit that includes a surface illumination and a louver layer making light emitted from the surface illumination be a plurality of parallel light sources; an imaging unit that captures an image using light emitted from the illumination unit and transmitted through a lens to be inspected; and a control unit that determines whether or not the lens to be inspected is acceptable by processing imaging data while adjusting a focus position of the imaging unit with respect to the lens to be inspected.

### SUMMARY

There is an inspection apparatus that captures an image using specularly reflected light, which is obtained in a case where a surface of an object is irradiated with light, and acquires the image as an image used to inspect a defect and the like formed on the surface. In such an inspection apparatus, a parallel light source irradiates a target region with parallel light and an imaging unit captures an image using specularly reflected light reflected from the target region. Since the specularly reflected light reflected from the target region is parallel light, an image is formed by a telecentric optical system of the imaging unit and is captured.

Here, in the inspection apparatus using the telecentric optical system, a lens aperture of the imaging unit is increased in size depending on the size of the target region to take specularly reflected light, which is reflected from the entire target region, into the imaging unit. In a case where the lens aperture is increased in size, an increase in the size of the inspection apparatus and an increase in cost due to an increase in the size of the inspection apparatus are caused.

Aspects of non-limiting embodiments of the present disclosure relate to an inspection apparatus and an inspection system that suppress an increase in the size of a lens aperture of an imaging unit as compared to a case where a telecentric optical system is used.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an inspection apparatus including: a limiting unit that is provided between a light source and a target region and limits light traveling from the light source toward the target region; and an imaging unit that captures an image using light passing through the limiting unit, reflected from the target region, and incident on the imaging unit. The limiting unit allows light, which travels in one direction and is incident on the imaging unit in a case where the light is specularly reflected from the target region, to pass and allows at least a part of light, which travels in other directions, not to pass, among light emitted from the light source.

### BRIEF DESCRIPTION OF THE DRAWINGS

Exemplary embodiment(s) of the present invention will be described in detail based on the following figures, wherein:

FIGS. 1A and 1B are conceptual diagrams showing an overall configuration example of an inspection apparatus to which a first exemplary embodiment is applied, FIG. 1A is a perspective view of the inspection apparatus, and FIG. 1B is a cross-sectional view corresponding to a cross section taken along line IA-IA of FIG. 1A;

FIGS. 2A and 2B are diagrams illustrating a structure example of an optical system of the inspection apparatus, FIG. 2A is a diagram schematically showing the internal structure of the inspection apparatus, and FIG. 2B is a diagram of FIG. 2A viewed from an upper side of a plane of paper (+z direction);

FIG. 3 is a diagram illustrating a light blocking wall group according to the first exemplary embodiment;

FIG. 4 is a diagram illustrating an inspection apparatus in the related art that uses a telecentric optical system;

FIG. 5 is a flowchart illustrating an example of an inspection operation that is performed by the inspection apparatus;

FIGS. 6A and 6B are diagrams illustrating the low-pass filtering of an inspection image;

FIG. 7 is a diagram illustrating a display example of an inspection result;

FIG. 8 is a diagram illustrating of a light blocking wall group of a modification example; and

FIGS. 9A and 9B are diagrams illustrating an inspection apparatus of an application example, FIG. 9A is a diagram schematically showing the internal structure of the inspection apparatus, and FIG. 9B is a diagram of FIG. 9A viewed from an upper side of a plane of paper (+z direction).

### DETAILED DESCRIPTION

Exemplary embodiments of the present invention will be described below with reference to the accompanying drawings.

In this specification, reflection in which an incidence angle and a reflection angle are different from each other may be referred to as “diffuse reflection” in contrast with specular reflection in which an incidence angle and a reflection angle are equal to each other. Further, reflected light caused by specular reflection may be referred to as “specularly reflected light”, reflected light caused by diffuse reflection may be referred to as “diffusely reflected light”, a component of reflected light corresponding to specularly reflected light may be referred to as “specular reflection component”, and a component of reflected light corresponding to diffusely reflected light may be referred to as “diffuse reflection component”.

### First Exemplary Embodiment

Overall Configuration of Inspection Apparatus 1

First, a first exemplary embodiment of the present invention will be described.

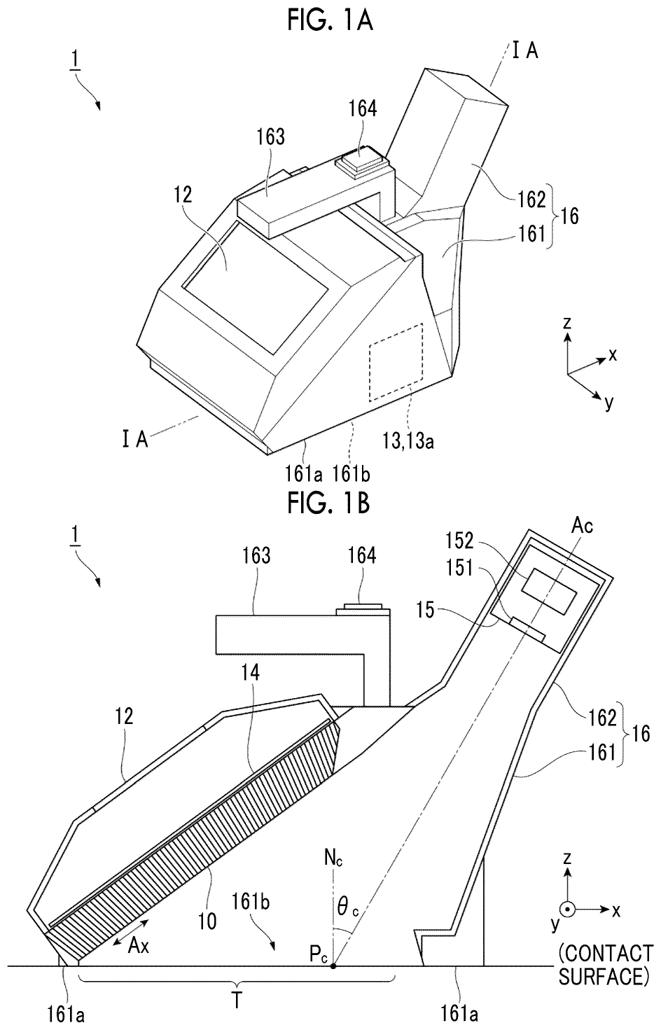

FIGS. 1A and 1B are conceptual diagrams showing an overall configuration example of an inspection apparatus 1 to which the first exemplary embodiment is applied, FIG. 1A is a perspective view of the inspection apparatus 1, and FIG. 1B is a cross-sectional view corresponding to a cross section taken along line IA-IA of FIGS. 1A and 1s shown together with a contact surface added for description. An upper right side of a plane of paper in FIG. 1A corresponds to +x direction, a lower right side thereof corresponds to +y direction, and an upper side thereof corresponds to +z direction; and a right side of a plane of paper in FIG. 1B corresponds to +x direction, a near (surface) side thereof corresponds to +y direction, and an upper side thereof corresponds to +z direction.

In the following description, a side of the inspection apparatus 1 on which a contact surface is positioned may be referred to as “down” and a side opposite thereto may be referred to as “up”.

As shown in FIGS. 1A and 1B, the inspection apparatus 1 to which the first exemplary embodiment is applied includes a light blocking wall group 10, a light source 12, a controller 13, a diffusion plate 14, a camera 15, and a case 16.

The inspection apparatus 1 to which the exemplary embodiment of the present invention is applied can image a target region T defined by a surface in a state where the inspection apparatus 1 is placed on the contact surface as shown in FIG. 1B. Then, the inspection apparatus 1 makes an inspection related to an object disposed in the target region T on the basis of a captured image (referred to as an “inspection image”.), and generates an inspection result.

The inspection apparatus 1 sets a defect, such as a sink mark or a weld formed on the surface of an object, as an inspection target. The sink mark is a sunken defect that occurs in a case where a molten material is cooled and hardened, and the weld is a streaky defect that occurs in a case where a molten material branches once and joins. In addition, various defects, such as flow marks and cracks caused by a manufacturing process and dents and scratches caused by the collision of an object, occurring on the surface may be set as an inspection target.

Further, the inspection apparatus 1 may be used to inspect dirt and the like adhering to an object.

Furthermore, the inspection apparatus 1 may set the workmanship, dimensions, and the like of an intentionally provided portion having a specific shape, such as a pattern, a groove, or a hole provided on the surface of an object, as an inspection target.

The controller 13 includes a central processing unit (CPU) 13a that is an example of a processor, and controls the entire inspection apparatus 1 as a system. For example, the controller 13 performs a control to cause the camera 15 to capture an inspection image as an imaging button 164 to be described later is pressed. Further, for example, the controller 13 performs a control to switch ON/OFF of the light source 12.

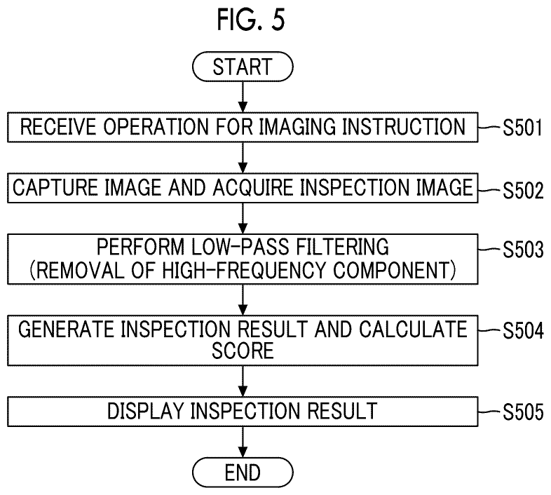

Furthermore, the controller 13 according to the exemplary embodiment of the present invention performs the image processing of the inspection image and processing, such as generating an inspection result, (which will be described later with reference to FIGS. 5 to 7) in addition to storing the inspection image captured by the camera 15.

The controller 13 is configured as a computer that includes a read only memory (ROM), a random access memory (RAM), and the like (all not shown) in addition to the CPU 13a, and the ROM includes a non-volatile rewritable memory, for example, a flash memory. Further, a program stored in the ROM is loaded into the RAM and the CPU 13a executes the program, so that various functions, such as image processing and generating an inspection result, are realized.

Further, the controller 13 includes an auxiliary storage device (not shown) and can store the captured inspection image and the generated inspection result.

An example in which the controller 13 is mounted on the inside (shown by a broken line) of the case 16 is shown in FIG. 1A, but may be mounted on the outside of the case 16.

The light source 12 is a device that emits light used for inspection, and emits light that travels at least in a direction in which the light blocking wall group 10 is positioned. The type of the light source 12 is not limited, and, for example, an incandescent lamp or a light emitting diode (LED) can be used.

Further, the color of the light emitted from the light source 12 is not limited. However, since light having a specific wavelength may be absorbed and the reflectance may be lowered depending on an object, white light in which light having a wavelength range of visible light is evenly mixed may be used as the light emitted from the light source 12.

The diffusion plate 14 is a member that is provided on the path of the light emitted from the light source 12 in the case 16 and diffuses light by scattering or the like. More specifically, the diffusion plate 14 diffuses light incident from the light source 12 and emits diffused light to the light blocking wall group 10.

The camera 15 is an example of an imaging unit of the exemplary embodiment of the present invention and is an imaging device that can image the target region T. For example, a charge coupled device (CCD) image sensor or a complementary metal oxide semiconductor (CMOS) image sensor can be used as an imaging element.

The camera 15 according to the exemplary embodiment of the present invention has an angle of view larger than zero. Further, the camera 15 takes light, which is incident on an imaging lens 151 of a non-telecentric optical system, into an imaging element 152 and captures the light as an inspection image.

As shown in FIG. 1B, an optical axis Ac of the imaging lens 151 of the camera 15 according to the present exemplary embodiment intersects with the contact surface at a point Pc in the target region T. In this case, an angle between the optical axis Ac of the camera 15 and the contact surface is denoted by Oc.

In other words, positioning (to be described later) using the case 16 (edge portion 161b) is performed such that the optical axis Ac and the contact surface intersect with each other at the point Pc and the angle between the optical axis Ac and the contact surface is a predetermined angle θc.

The case 16 is a member that forms the appearance of the inspection apparatus 1, and has a hollow structure.

Further, the light blocking wall group 10, the light source 12, the diffusion plate 14, the camera 15, and the like are mounted inside the hollow structure, so that the inspection apparatus 1 is formed. That is, the case 16 has a role of a housing that holds and protects the light source 12, the camera 15, and the like in the inspection apparatus 1.

As shown in FIG. 1B, the case 16 according to the exemplary embodiment of the present invention includes a light source mounting portion 161 and a camera mounting portion 162 having a continuous hollow structure.

The light source mounting portion 161 is a portion on which the light blocking wall group 10, the light source 12, and the diffusion plate 14 are mounted. Further, an opening portion 161a through which irradiation light emitted from the light source 12 and reflected light reflected from the surface of an object are input and output and an edge portion 161b that surrounds an outer edge of the opening portion 161a are provided on the lower side of the light source mounting portion 161 (a side corresponding to −z direction in FIGS. 1A and 1B).

In the exemplary embodiment of the present invention, the opening portion 161a may be used as an introduction port that is used to dispose an object in the target region T.

Further, the edge portion 161b functions as a positioning portion that is in contact with the contact surface during the capturing of an inspection image, allows the target region T and the camera 15 to be positioned with a predetermined distance and a predetermined angle, and positions the camera 15 with respect to an object in addition to functioning as a leg portion that supports the entire inspection apparatus 1.

The light source 12 is mounted on the light source mounting portion 161 above at least the opening portion 161a and the edge portion 161b.

Further, the diffusion plate 14 and the light blocking wall group 10 are mounted on the light source mounting portion 161 between the light source 12 and the target region T in order from a side close to the light source 12.

The camera mounting portion 162 is a portion on which the camera 15 is mounted.

More specifically, the camera mounting portion 162 according to the exemplary embodiment of the present invention holds the camera 15 such that the optical axis Ac of the imaging lens 151 intersects with the contact surface at an angle θc formed at the point Pc.

The inspection apparatus 1 to which the present exemplary embodiment is applied is adapted such that an optical element and the like are not provided between the camera 15 and the target region T in the camera mounting portion 162 and light (reflected light) from the target region T is directly taken into the camera 15.

In the inspection apparatus 1 to which the exemplary embodiment of the present invention is applied, an edge portion 161b of the case 16 is in contact with the contact surface with substantially no gap between the contact surface and the edge portion 161b. Further, the case 16 has a closed structure at a portion other than the opening portion 161a. Accordingly, the case 16 according to the present exemplary embodiment also has a role of preventing or reducing the incidence of external light or ambient light on the inside.

In addition, as shown in FIG. 1B, the case 16 according to the present exemplary embodiment includes a grip portion 163 that can be gripped during the movement or installation of the inspection apparatus 1.

Further, the case 16 includes an imaging button 164 as a physical button that is used to receive an instruction to capture an inspection image from a user. In a case where the imaging button 164 is pressed, the controller 13 controls the camera 15 to cause the camera 15 to capture an inspection image.

Furthermore, a power button that is used to switch ON/OFF of power of the inspection apparatus 1, and the like may be provided.

The light blocking wall group 10 limits a part of light that is incident via the diffusion plate 14 and travels from the light source 12 toward the target region T without causing a part of the light to pass. More specifically, the light blocking wall group 10 is an example of a limiting unit that allows light, which travels in one direction and is incident on the camera 15, to pass and allows at least a part of light, which passes in other directions, not to pass in a case where light is specularly reflected in the target region T.

The light blocking wall group 10 includes a plurality of light blocking walls that are provided to be arranged, and allows light to pass through openings provided between the respective light blocking walls. That is, the light blocking wall group 10 allows light, which is incident on the light blocking walls, not to pass (blocks light) and allows light, which is incident on the openings, to pass to limit light that travels toward the target region T. The light blocking wall is made of a material, which absorbs light emitted from the light source 12, or the like such that the reflectance of the light blocking wall is low. In the exemplary embodiment of the present invention, for example, a black resin material is used to correspond to a case where the light source 12 is a white light source. Further, the plurality of light blocking walls forming the light blocking wall group 10 are arranged in a direction Ax intersecting with a direction that is directed to the target region T from the light source 12.

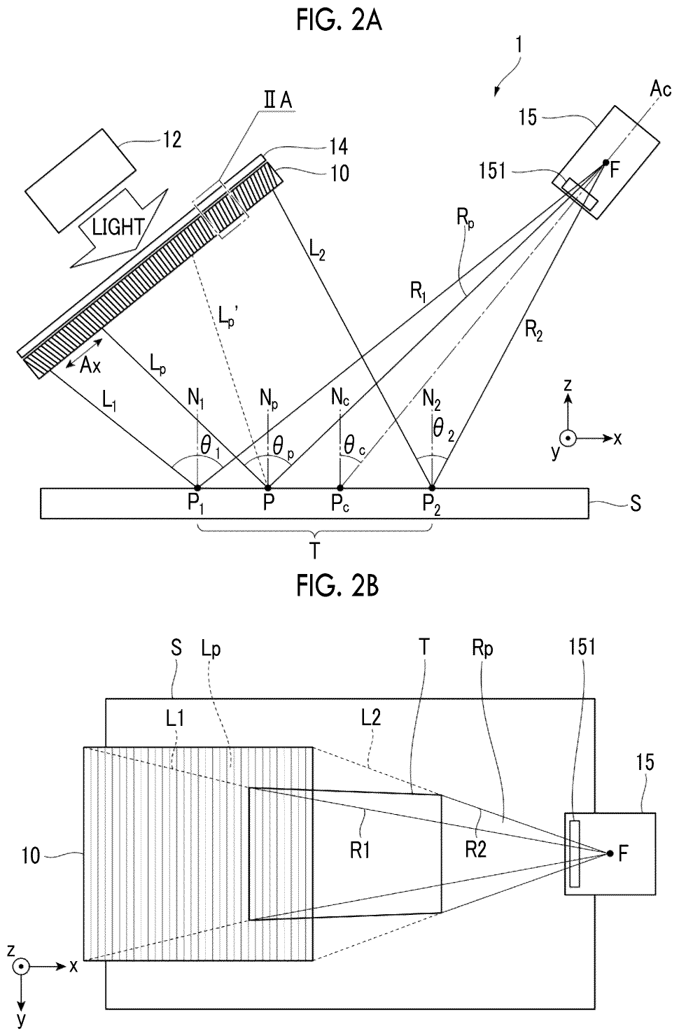

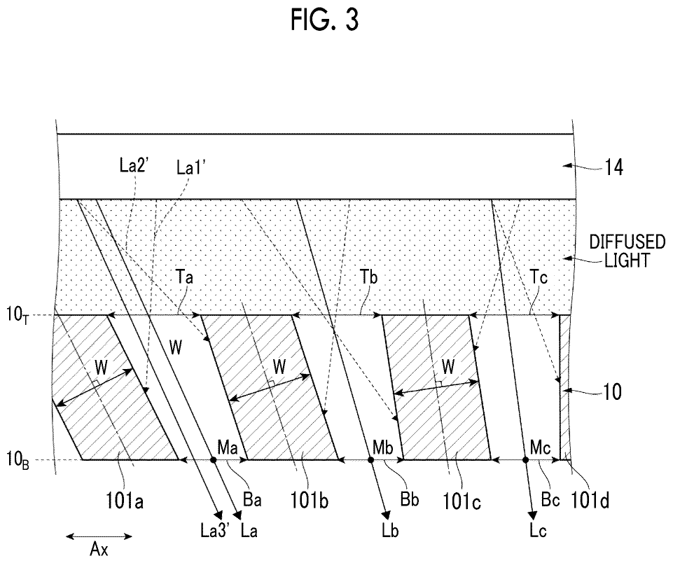

The light blocking wall group 10 will be described in detail later with reference to FIGS. 2A and 2B and FIG. 3.

In addition, the inspection apparatus 1 may be provided with, for example, a display formed of a liquid crystal display or an organic EL display, a touch panel, or the like. Since the inspection image or the inspection result is displayed on, for example, the display provided in the inspection apparatus 1, the inspection image or the inspection result can be read by a user. Further, an operation input from a user may be received by a touch panel. In this case, a physical button, such as the imaging button 164, may not be provided and an inspection image may be captured in response to the operation of the touch panel.

Furthermore, the inspection apparatus 1 may be provided with a communication interface (IF). The inspection image and the inspection result may be transmitted to an external device via this communication IF, and may be adapted to be readable from the device that is a destination of transmission. For example, an Ethernet (registered trademark) module, a universal serial bus (USB), a wireless LAN, or the like can be used as the communication IF.

Optical System of Inspection Apparatus 1

Next, an optical system of the inspection apparatus 1 to which the exemplary embodiment of the present invention is applied will be described in detail with reference to FIGS. 2A and 2B and FIG. 3.

FIGS. 2A and 2B are diagrams illustrating a structure example of the optical system of the inspection apparatus 1, FIG. 2A is a diagram schematically showing the internal structure of the inspection apparatus 1, and FIG. 2B is a diagram of FIG. 2A viewed from an upper side of a plane of paper (+z direction). Some components of the inspection apparatus 1 are not shown for description.

FIG. 3 is a diagram illustrating the light blocking wall group 10 according to the first exemplary embodiment, and corresponds to an enlarged view of a region II A of FIG. 2A.

An example in which an object S larger than the target region T is imaged and inspected is shown in FIGS. 2A and 2B, and the inspection apparatus 1 is in contact with a surface of the object S. That is, the surface of the object S serves as a contact surface. In a case where an object smaller than the target region T is imaged and inspected, the object is disposed on a flat surface of a workbench or the like and this workbench or the like may be used as a contact surface.

In a case where an inspection image is captured, the inspection apparatus 1 irradiates the entire target region T with light. For example, as shown in FIG. 2A, the inspection apparatus 1 irradiates the target region T with light from a point P1 that is one end (an end corresponding to −x direction) of the target region T to a point P2 that is the other end (an end corresponding to +x direction) thereof. Then, reflected light reflected from each point P between P1 and P2 is taken into the imaging lens 151 of the camera 15 and an inspection image is captured.

Here, each point P is irradiated with light incident on the camera 15 under a specular reflection condition. That is, in a case where a perpendicular Np to the contact surface (the surface of the object S) at the point P is considered, irradiation light Lp, which allows an angle between irradiation light Lp applied to the point P and the perpendicular Np and an angle between specularly reflected light Rp and the perpendicular Np to be identical and an angle θp, is emitted. The same applies to a point Pc (see FIGS. 1A and 1B) in addition to the points P1 and P2 described above.

On the other hand, as with light Lp′ shown in FIG. 2A by a broken line, at least a part of light of which specularly reflected light is not incident on the camera 15, that is, an angle between specularly reflected light and the perpendicular Np is not Op is limited by the light blocking wall group 10 and is not emitted to the point P.

In addition, the angle θp is reduced from the point P1 that is one end (an end corresponding to −x direction) of the target region T in a direction away from the camera 15 toward the point P2 that is the other end (an end corresponding to +x direction) of the target region T in a direction approaching the camera 15. Further, specularly reflected light reflected at each point P in the target region T is positioned between reflected light R1 that is reflected at the point P1 of FIG. 2A and reflected light R2 that is reflected at the point P2.

Furthermore, pieces of specularly reflected light Rp reflected from the respective points P in the target region T have an intersection F positioned on the optical axis Ac on the emission side of the imaging lens 151. That is, the specularly reflected light Rp reflected at each point P in the target region T is concentrated toward the optical axis Ac. Then, this light is incident on the imaging lens 151 having a stop at an optical position corresponding to the intersection F and reaches the imaging element 152 (see FIGS. 1A and 1B), so that an inspection image is captured.

An optical path in the x direction has been described in FIG. 2A. In the inspection apparatus 1 to which the exemplary embodiment of the present invention is applied, a lot of diffusion components with respect to light emitted from the width direction (y direction) of the light blocking wall group 10 are included in the y direction but the diffusion components do not particularly greatly affect an observation result of a linear defect extending in the y direction. The reason for this is that the surface shape of a linear defect extending in the y direction mostly has an inclination in the x direction. Only specular reflection components, which have strong influence and pass through the intersection F, are shown in FIG. 2B and a region in which the specular reflection components are present is the target region T.

As shown in FIG. 3, the light blocking wall group 10 according to the present exemplary embodiment is formed of a plurality of light blocking walls 101a, 101b, 101c, 101d, . . . (which may be denoted by 101 without being distinguished). Further, incident-side openings Ta, Tb, Tc, . . . on which light emitted from the light source 12 is incident via the diffusion plate 14 and emission-side openings Ba, Bb, Bc, . . . from which light is emitted toward the target region T are provided between the respective light blocking walls 101.

All of the light blocking walls 101 according to the first exemplary embodiment have an identical width W as shown in FIG. 3. Then, the light blocking walls 101 are arranged such that end faces of the light blocking walls 101 are not parallel to each other in a direction in which the respective light blocking walls 101 are arranged (a right-left direction in FIG. 3). In other words, the respective light blocking walls 101 are arranged such that axes perpendicular to the widths W (shown in FIG. 3 by a one-dot chain line) are not parallel to each other (have an intersection on extension lines). In addition, since the respective light blocking walls 101 are arranged not in parallel to each other, the emission-side openings are smaller in a case where the corresponding incident-side openings Ta, Tb, Tc, . . . and the corresponding emission-side openings Ba, Bb, Bc, . . . are compared with each other. The inclination of the axis may be referred to as the inclination of the light blocking wall 101.

Further, each light blocking wall 101 includes an upper end that is an incident-side end portion and a lower end that is an emission-side end portion. Since each of the upper ends and lower ends of all the light blocking walls 101 are arranged in a straight line in this example, a straight line along which the upper ends are arranged is referred to as an upper end 10T and a straight line along which the lower ends are arranged is referred to as a lower end 10B.

The light blocking wall group 10 limits the passage of light through each of the emission-side openings Ba, Bb, Bc, . . . on the basis of the inclination of the light blocking wall 101, an interval between the light blocking walls 101, and the length of the light blocking wall 101. In other words, with regard to light incident on the incident-side openings Ta, Tb, Tc, . . . , the light blocking wall group 10 allows light, which satisfies conditions (hereinafter, referred to as “incidence conditions”) determined for an incident position and an incident angle, to pass and allows at least a part of other light not to pass.

The length of the light blocking wall 101 is a dimension in a direction (a vertical direction in FIG. 3) intersecting with the width W and a direction in which the light blocking walls 101 are arranged.

More specifically, diffused light, which is diffused by the diffusion plate 14, is incident on each of the incident-side openings Ta, Tb, Tc, . . . . For example, light La satisfying the incidence conditions is incident on the incident-side opening Ta as shown by an arrow shown by a solid line. Further, light La1′ and light La2′ not satisfying the incidence conditions are incident as shown by arrows shown by a broken line.

Further, the light La, which satisfies the incidence conditions, among the light incident on the incident-side opening Ta, passes through the emission-side opening Ba without hitting the light blocking walls 101a and 101b. For example, as shown in FIG. 3, the light La passes through a midpoint Ma of the emission-side opening Ba. Accordingly, the target region T is irradiated with the light La satisfying the incidence conditions. On the other hands, the light La1′ and the light La2′ not satisfying the incidence conditions hit the light blocking walls 101a and 101b in the middle of a path toward the emission-side opening Ba and are absorbed. Accordingly, the light La′ not satisfying the incidence conditions does not reach the emission-side opening Ba. As a result, the target region T is not irradiated with the light La′.

Here, the light blocking wall group 10 according to the exemplary embodiment of the present invention not only allows light satisfying the incidence conditions to pass, but also allows a part of light not satisfying the incidence conditions to pass. For example, light La3′ shown in FIG. 3 is light that is incident on the incident-side opening Ta at an angle identical to the angle of the light La from a position different from the position corresponding to the light La, and does not satisfy the incidence conditions according to the incident-side opening Ta. However, the light La3′ passes through the emission-side opening Ba as shown in FIG. 3, and the target region T is irradiated with the light La3′. Which light among the light not satisfying the incidence conditions is allowed to pass (hereinafter, referred to as “allowable range”) is determined depending on an interval between the respective light blocking walls 101 and the angle and length of each light blocking wall 101.

That is, the light blocking wall group 10 according to the exemplary embodiment of the present invention may allow the light satisfying the incidence conditions to pass and allow at least a part of the light not satisfying the incidence conditions not to pass, and does not need to limit all the light not satisfying the incidence conditions.

Further, light emitted from each of the emission-side openings Ba, Bb, Bc, . . . of the light blocking wall group 10 is specularly reflected at the corresponding point P and is incident on the camera 15 (see FIG. 2A).

In this example, the light La satisfying the incidence conditions is an example of light traveling in one direction and the light La1′, the light La2′, and the light La3′ not satisfying the incidence conditions are an example of light traveling in other directions. Light Lb, light Lc, . . . (arrows shown in FIG. 3 by a solid line) satisfying the incidence conditions, which are an example of light traveling in one direction, are present likewise in the incident-side openings Tb, Tc, . . . as well. Further, light (arrows shown in FIG. 3 by a broken line), which is the light not satisfying the incidence conditions and does not pass through the emission-side openings Bb, Bc, . . . , are present likewise.

In this way, the light blocking wall group 10 according to the first exemplary embodiment functions as an example of a limiting unit that allows light, which travels in one direction and is incident on the camera 15 in a case where the light is specularly reflected in the target region T, to pass and allows at least a part of light, which travels in other directions, not to pass.

Further, as a result of the limitation of light, which travels toward the target region T, made by the light blocking wall group 10, specular reflection components of reflected light incident on the camera 15 are increased in the inspection apparatus 1 to which the exemplary embodiment of the present invention is applied as compared to an inspection apparatus in which light traveling toward the target region T is not limited. In an inspection apparatus that captures an image using the reflected light to make an inspection, the accuracy of inspection is improved as specular reflection components of the reflected light are increased. Accordingly, the accuracy of inspection of the inspection apparatus 1 to which the exemplary embodiment of the present invention is applied may be improved as compared to an inspection apparatus in which light traveling toward the target region T is not limited.

The light limited by the light blocking wall group 10 is, for example, light, which travels in a direction approaching the camera 15, among light that is incident on the incident-side openings Ta, Tb, Tc, . . . and does not satisfy the incidence conditions.

For example, in the example shown in FIG. 3, the light La1′ not satisfying the incidence conditions is light traveling in a direction away from the camera 15. On the other hand, the light La2′ not satisfying the incidence conditions is light traveling in a direction approaching the camera 15. In a case where the light La1′ and the light La2′ not satisfying the incidence conditions are applied to the target region T and form reflected light without being limited by the light blocking wall group 10, the light La1′ traveling in a direction approaching the camera 15 is more likely to be incident on the camera 15 as a diffusion component than the light La2′ traveling in a direction away from the camera 15.

As described above, in the inspection apparatus that captures an image using the reflected light to make an inspection, the accuracy of inspection is improved as specular reflection components of the reflected light are increased. Accordingly, in a case where the light La1′ traveling in a direction approaching the camera 15 is limited, the accuracy of inspection may be improved as compared to a case where light traveling in a direction approaching the camera 15 is not limited.

As a more specific example, the light blocking wall group 10 may limit light, which forms an angle of 20° or more with the light La satisfying the incidence conditions, among the light not satisfying the incidence conditions. That is, the inclinations of the light blocking walls 101a and 101b and an interval between the light blocking walls 101a and 101b may be adjusted such that light, which forms an angle of 20° or more with the light La satisfying the incidence conditions, does not pass through the emission-side opening Ba.

Further, light may be limited by the light blocking wall group 10 such that, for example, the amount of light not satisfying the incidence conditions but allowed to pass as with the light La3′ is equal to or less than 50% of the amount of light satisfying the incidence conditions as with the light La among the light passing through the emission-side openings Ba, Bb, Bc, . . . . That is, for example, the light blocking wall group 10 may be designed such that the amount of light traveling in one direction and applied to the target region T is 50% of the amount of light traveling in other directions. Accordingly, since contrast between a defective portion and a normal portion of an inspection image is increased as compared to a case where a ratio of the amount of light is set to be larger than 50%, the accuracy of inspection may be improved.

Furthermore, as the interval at which the respective light blocking walls 101 are arranged in the light blocking wall group 10 is reduced, an allowable range for the light not satisfying the incidence conditions is reduced. That is, diffusion components of the reflected light are decreased and specular reflection components are increased. An interval at which the respective light blocking walls 101 are arranged can be set to, for example, 1.5 mm or less.

Here, an inspection apparatus in the related art that uses a telecentric optical system (hereinafter, simply referred to as “an inspection apparatus in the related art”) will be described as a comparative example to which the exemplary embodiment of the present invention is not applied.

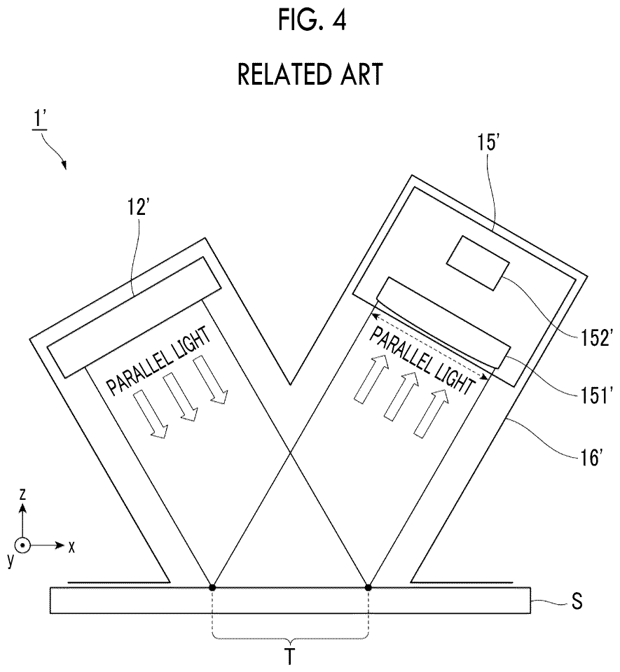

FIG. 4 is a diagram illustrating an inspection apparatus 1′ in the related art that uses a telecentric optical system. Each component of the inspection apparatus 1′ in the related art corresponding to each component of the inspection apparatus 1 to which the exemplary embodiment of the present invention is applied is denoted by an identical reference numeral to which “′” is added. Further, the description of components substantially identical to the components of the inspection apparatus 1 to which the exemplary embodiment of the present invention is applied may be omitted.

As shown in FIG. 4, the inspection apparatus 1′ in the related art includes a light source 12′ that emits parallel light, a camera 15′ that takes in reflected light reflected from a target region T to capture an inspection image, and a case 16′ that serves as a housing.

The camera 15′ of the inspection apparatus 1′ in the related art includes an imaging lens 151′ and an imaging element 152′.

Here, in the inspection apparatus 1′ in the related art, in order to improve the accuracy of inspection, the light source 12′ that is a parallel light source is used to increase specular reflection components of reflected light. In a case where the target region T is irradiated with parallel light emitted from the light source 12′, specular reflection components of reflected light reflected from the target region T are substantially parallel light. Accordingly, as shown in FIG. 4 by a double-headed arrow shown by a broken line, the reflected light has a width substantially equal to the width of the target region T and reaches the camera 15′.

In this case, in order to capture an image using the reflected light, it is necessary to refract and concentrate the reflected light by the imaging lens 151′ and to cause the reflected light to be incident on the imaging element 152′. That is, a telecentric lens having a width substantially equal to the width of the target region T needs to be used as the imaging lens 151′ and needs to have a lens aperture having widths, which are substantially equal to the widths of the target region T in a y direction and an x direction, in one direction and other directions.

On the other hand, since light incident on the target region T is limited by the light blocking wall group 10 in the inspection apparatus 1 to which the exemplary embodiment of the present invention is applied, specular reflection components of the reflected light are increased. Accordingly, light applied to the target region T is not parallel light, so that specular reflection components of reflected light reflected from the target region T are not parallel light. Therefore, the imaging lens 151 according to the exemplary embodiment of the present invention does not need to be a telecentric lens having widths, which are substantially equal to the widths of the target region T in a y direction and an x direction, in one direction and other directions. Then, the width and the lens aperture of the imaging lens 151 may be smaller than the target region T.

As described above, an increase in the size of a lens aperture is suppressed in the inspection apparatus 1 according to the exemplary embodiment of the present invention as compared to the inspection apparatus 1′ in the related art that uses a telecentric optical system. Accordingly, an increase in cost and an increase in the size of the entire apparatus caused by an increase in the size of a lens aperture are suppressed.

In addition, as described with reference to FIG. 2A, in the inspection apparatus 1 to which the exemplary embodiment of the present invention is applied, pieces of the specularly reflected light Rp reflected from the respective points P arranged in the x direction have an intersection F on the emission side of the imaging lens 151. Accordingly, the specularly reflected light Rp, which is reflected from the target region T and reaches the camera 15, is concentrated in a range narrower than the target region T in the x direction. Therefore, the size of the imaging lens 151 may be equal to or larger than the size of a range in which the specularly reflected light Rp is concentrated, and an increase in the size of the lens aperture of the imaging lens 151 is suppressed.

Incidentally, since the light blocking walls 101 (see FIGS. 2A and 2B and FIG. 3) are arranged in the direction Ax in the inspection apparatus 1 to which the first exemplary embodiment is applied, diffusion components are suppressed in the x direction of the target region T but diffusion components are difficult to be suppressed in the y direction. As a result, a defect extending in the x direction (having a longitudinal direction) is more easily observed on the surface of the object S than a defect extending in the y direction. Further, a defect occurring on the object S may have a property in which a defect easily extends in a specific direction due to a manufacturing process, a shape, or the like. Accordingly, the object S may be disposed at the time of the inspection of the object S such that, for example, the x direction of the target region T coincides with a direction in which a defect easily extends on the object S.

Inspection Operation

Next, an operation related to an inspection (hereinafter, referred to as an “inspection operation”) made by the inspection apparatus 1 will be described. The inspection operation according to the exemplary embodiment of the present invention includes capturing an inspection image, low-pass filtering for the inspection image, and generating an inspection result based on the inspection image subjected to the low-pass filtering.

FIG. 5 is a flowchart illustrating an example of the inspection operation that is performed by the inspection apparatus 1. Reference letter S shown in FIG. 5 means a step.

As a premise, in the inspection apparatus 1 to which the present exemplary embodiment is applied, the light source 12 (see FIGS. 1A and 1B) is turned on by the operation of the power button, imaging performed by the camera 15 is started, and the inspection operation is started.

A captured image is displayed on the display (not shown) included in the inspection apparatus 1 in real time.

First, the controller 13, which starts the inspection operation in response to the operation of the power button, receives an operation for an imaging instruction (S501). As described above with reference to FIGS. 1A and 1B, since an operation for an imaging instruction is performed using the imaging button 164 in the inspection apparatus 1 to which the present exemplary embodiment is applied, the controller 13 receives the pressing of the imaging button 164 performed by a user.

Upon receiving the operation for an imaging instruction, the controller 13 captures an image using reflected light taken into the camera 15 at that time and acquires the image as an inspection image (S502).

Next, the controller 13 performs low-pass filtering on the inspection image (S503).

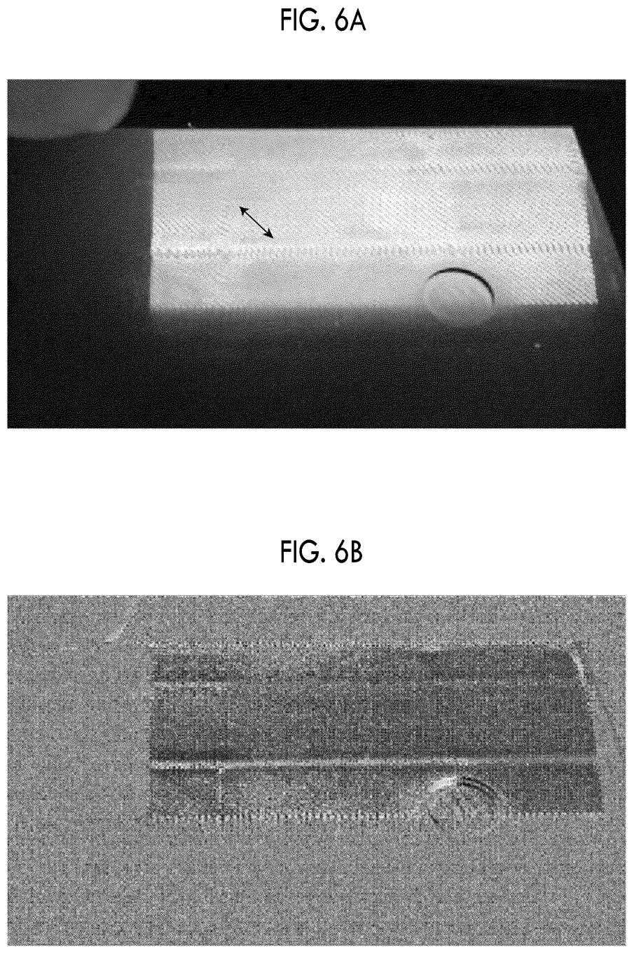

Here, the low-pass filtering will be described with reference to FIGS. 6A and 6B. FIGS. 6A and 6B are diagrams illustrating the low-pass filtering of the inspection image, FIG. 6A corresponds to the inspection image not subjected to the low-pass filtering yet, and FIG. 6B corresponds to the inspection image subjected to the low-pass filtering.

Since light traveling toward the target region T is limited by the light blocking wall group 10 in the inspection apparatus 1 to which the exemplary embodiment of the present invention is applied, regions not irradiated with light may be generated in the target region T. Further, since reflected light is not generated from the regions not irradiated with light, the regions not irradiated with light form regions having a low brightness in the inspection image. As a result, a stripe pattern in which bright (high-brightness) portions and dark (low-brightness) portions are alternately arranged may be included in the inspection image as shown in FIG. 6A.

Although described later, the inspection apparatus 1 to which the exemplary embodiment of the present invention is applied generates an inspection result on the basis of the brightness profile of the inspection image. For this reason, in a case where the above-mentioned stripe pattern is included in the inspection image, there may be a concern that the accuracy of inspection will be adversely affected.

Accordingly, in the exemplary embodiment of the present invention, the low-pass filtering is performed on the inspection image before the generation of the inspection result. Here, the low-pass filtering is processing of leaving frequency components lower than a predetermined spatial frequency and removing frequency components equal to or higher than the predetermined spatial frequency. The stripe pattern generated in the inspection image has a spatial frequency corresponding to an interval between the light blocking wall 101 (see FIG. 3) of the light blocking wall group 10. Accordingly, in a case where the low-pass filtering is performed in a state where a spatial frequency corresponding to an interval between the light blocking walls 101 is set to a predetermined spatial frequency, dark (low-brightness) portions are removed and the stripe pattern of the inspection image is removed as shown in FIG. 6B. As a result, the accuracy of inspection may be improved as compared to a case where the low-pass filtering is not performed.

Returning to FIG. 5, the description of the inspection operation is resumed.

In S504, an inspection result is generated on the basis of the inspection image. In the exemplary embodiment of the present invention, the number, sizes, and types of defects are specified from the brightness profile of the inspection image subjected to the low-pass filtering in S503 and corresponding numerical values (scores) are calculated.

The score is a numerical value that indicates the degree of influence of a defect on the quality of the object S. For example, the score is calculated to be higher as the number of defects is larger and as the defects are larger. Further, for example, the score is calculated to be higher in the case of the type of a defect of which the influence on the quality of the object S is larger among defects, such as a sink mark and a weld. The score is an example of an inspection result generated on the basis of an inspection image.

The inspection result generated in S504 is displayed on the display of the inspection apparatus 1 (S505).

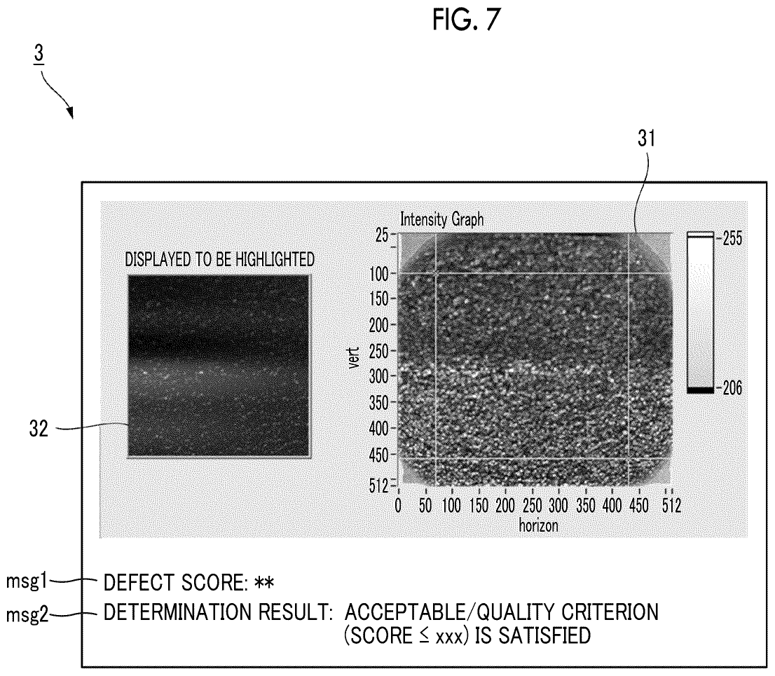

FIG. 7 is a diagram illustrating a display example of the inspection result. Here, an example of a case where the inspection result is displayed on the display 3 of the inspection apparatus 1 will be described.

As shown in FIG. 7, for example, an inspection image 31 that is used for the generation of the inspection result and an image 32 in which a defective portion of the inspection image is displayed to be highlighted are displayed on the display 3. Further, a text msg1 indicating a calculated defect score ** is displayed as the inspection result generated in S504. In addition, whether or not the inspection result satisfies a predetermined criterion may be displayed. In the example shown in FIG. 7, a fact that the calculated defect score ** satisfies a predetermined criterion (quality criterion) of “score≤xxx” is displayed as shown as a text msg2.

A method of displaying the inspection result is an example and may be any method that allows a user to ascertain the inspection result.

Further, the inspection result may be transmitted to another device via the communication IF (described with reference to FIGS. 1A and 1B), and may be displayed on the other device that is a destination of transmission. In this case, the inspection apparatus 1 does not necessarily need to include the display 3.

The inspection operation of the inspection apparatus 1 to which the exemplary embodiment of the present invention is applied is performed by the processing of S501 to S505 described above with reference to FIG. 5.

As described above, the operation shown in FIG. 5 is an example, and some processes may be removed or other processes not described above may be added as long as there is no contradiction. For example, the low-pass filtering shown in S503 is not an indispensable process, and the inspection image acquired in S502 may be used for inspection (the processing may proceed to S504) as it is. In this case, the controller 13 does not need to have a function of the low-pass filtering.

Further, the inspection image acquired in S502, the inspection image subjected to the low-pass filtering in S503, the inspection result generated in S504, and the like may be stored in the auxiliary storage device (described with reference to FIGS. 1A and 1B) of the inspection apparatus 1 as information that can be taken out and displayed later on the basis of a user's operation.

The above-mentioned inspection apparatus 1 to which the first exemplary embodiment is applied is understood as an inspection apparatus including the light blocking wall group 10 that is provided between the light source 12 and a target region and limits light traveling from the light source 12 toward the target region T and the camera 15 that captures an image using light passing through the light blocking wall group 10, reflected from the target region T, and incident on the camera 15. The light blocking wall group 10 allows light (for example, the light La in FIG. 3), which travels in one direction and is incident on the camera 15 in a case where the light is specularly reflected from the target region T, to pass and allows at least a part of light (for example, the light La1′ and the light La2′ in FIG. 3), which travels in other directions, not to pass, among light emitted from the light source 12.

Further, the inspection apparatus 1 can also be understood as an imaging apparatus that captures an inspection image with the above-mentioned configuration.

Furthermore, the inspection apparatus 1 to which the first exemplary embodiment is applied is also understood as an inspection system including the light blocking wall group 10 that is provided between the light source 12 and a target region and limits light traveling from the light source 12 toward the target region T, the camera 15 that captures an image using light passing through the light blocking wall group 10, reflected from the target region T, and incident on the camera 15, and the processor 13a that performs low-pass filtering on the image captured by the camera 15. The light blocking wall group 10 allows light (for example, the light La in FIG. 3), which travels in one direction and is incident on the camera 15 in a case where the light is specularly reflected from the target region T, to pass and allows at least a part of light (for example, the light La1′ and the light La2′ in FIG. 3), which travels in other directions, not to pass, among light emitted from the light source 12.

### Modification Example of Light Blocking Wall Group 10

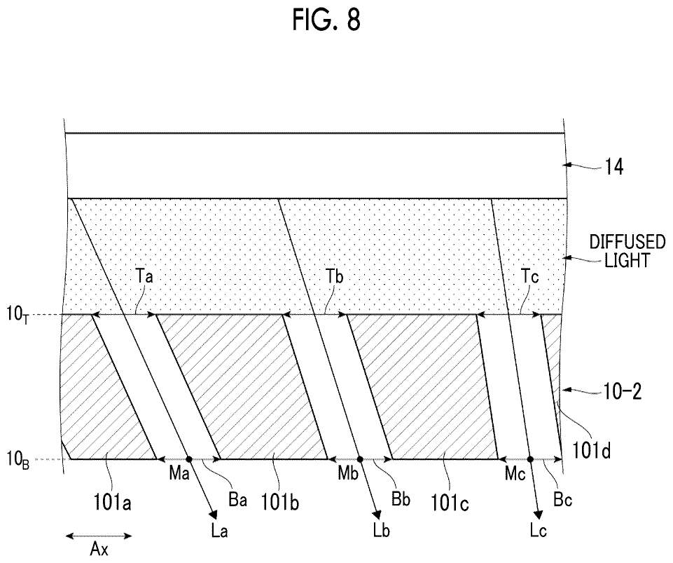

Here, a modification example of the light blocking wall group will be described with reference to FIG. 8.

FIG. 8 is a diagram illustrating of a light blocking wall group 10-2 of a modification example, and is an enlarged view of a part of the light blocking wall group 10-2 as with the light blocking wall group 10 shown in FIG. 3.

Components of the light blocking wall group 10-2 of the modification example corresponding to the components of the light blocking wall group 10 described with reference to FIG. 3 will be denoted by reference numerals identical to the reference numerals of the components of the light blocking wall group 10, and the detailed description thereof will be omitted.

In the light blocking wall group 10 described with reference to FIG. 3, the plurality of light blocking walls 101 having an identical width W are arranged not in parallel to each other to adjust the incident-side openings Ta, Tb, Tc, . . . and the emission-side openings Ba, Bb, Bc, . . . and to limit light passing through the emission-side openings Ba, Bb, Bc, . . . .

In the light blocking wall group 10-2 of the modification example shown in FIG. 8, the width of each light blocking wall 101 is not constant. More specifically, two end faces (horizontal end faces in FIG. 8) of the light blocking wall 101, which form each of the incident-side openings Ta, Tb, Tc, . . . and each of the emission-side openings Ba, Bb, Bc, . . . are made not parallel to adjust the incident-side openings Ta, Tb, Tc, . . . and the emission-side openings Ba, Bb, Bc, . . . and to limit light passing through the emission-side openings Ba, Bb, Bc, . . . .

As with the light blocking wall group 10, the light blocking wall group 10-2 of the modification example can also limit light, which travels from the light source 12 toward the target region T, to allow light La, light Lb, light Lc, . . . satisfying the incidence conditions to pass and to allow at least a part of light not satisfying the incidence conditions not to pass.

Further, even in a case where the light blocking wall group 10 of the inspection apparatus 1 described with reference to FIGS. 1A and 1B and the like is replaced with the light blocking wall group 10-2, effects identical to effects obtained in a case where the light blocking wall group 10 is used are obtained.

### Second Exemplary Embodiment

In the above-mentioned first exemplary embodiment, light traveling from the light source 12 toward the target region T is limited by the light blocking wall group 10 that consists of a plurality of light blocking walls 101 arranged in a direction intersecting with a direction in which light is allowed to pass.

An inspection apparatus 1-2 (hereinafter, reference numeral 1-2 is used to distinguish this inspection apparatus from the inspection apparatus 1 to which the first exemplary embodiment is applied) to which a second exemplary embodiment is applied is different from the inspection apparatus 1 only in that a limiting layer as an example of a limiting unit is provided instead of the light blocking wall group 10 included in the inspection apparatus 1 to which the first exemplary embodiment is applied. Since the other portions are identical to the other portions of the first exemplary embodiment, a description will be made using reference numerals identical to the reference numerals of the first exemplary embodiment with reference to FIGS. 1A and 1B and FIG. 2.

Here, the limiting layer is adapted such that portions transmitting light emitted from the light source 12 and portions not transmitting the light are alternately arranged. More specifically, the limiting layer has a configuration in which portions transmitting light emitted from the light source 12 and portions not transmitting the light are alternately arranged in the direction Ax in which the light blocking walls 101 of the light blocking wall group 10 are arranged in the example shown in FIGS. 1A and 1B.

In the limiting layer, for example, a transparent resin material can be used for the portions transmitting light and, for example, a black resin material can be used for the portions not transmitting light.

Such a limiting layer can also be provided with the incident-side openings Ta, Tb, Tc, . . . and the emission-side openings Ba, Bb, Bc, . . . identical to the light blocking wall group 10 according to the first exemplary embodiment shown in FIG. 3, and can limit light traveling from the light source 12 toward the target region T as with the light blocking wall group 10.

Here, the limiting layer may be formed of a film and may be adapted to be deformable. In this case, for example, the film may be bent in use to be orthogonal to a traveling direction of light to be transmitted (a traveling direction of the light La in FIG. 3).

Since the film is used, the limiting layer may be formed to be thin. As a result, it may be possible to contribute to a reduction in the size and weight of the entire inspection apparatus 1-2.

Further, in a case where the degree of bending of a film is set to vary, it is also possible to adjust light of which the passage is to be limited or allowed.

The second exemplary embodiment is not limited to a case where one limiting layer corresponding to the target region T is provided, and, for example, a plurality of limiting layers may be arranged in use. More specifically, a plurality of limiting layers may be arranged in use in the direction Ax in which the light blocking walls 101 of the light blocking wall group 10 are arranged in the example shown in FIGS. 1A and 1B. In a case where the plurality of limiting layers are arranged in use, the degree of freedom in the arrangement of the limiting layers may be increased as compared to a case where one limiting layer is used.

Further, in a case where the inclinations or thicknesses of the respective limiting layers are set to vary, it is also possible to adjust light of which the passage is to be limited or allowed.

The above-mentioned inspection apparatus 1-2 to which the second exemplary embodiment is applied is understood as an inspection apparatus including the limiting layer that is provided between the light source 12 and a target region and limits light traveling from the light source 12 toward the target region T and the camera 15 that captures an image using light passing through the limiting layer, reflected from the target region T, and incident on the camera 15. The limiting layer allows light, which travels in one direction and is incident on the camera 15 in a case where the light is specularly reflected from the target region T, to pass and allows at least a part of light, which travels in other directions, not to pass, among light emitted from the light source 12.

Further, as in the first exemplary embodiment, the inspection apparatus 1-2 is also understood as a corresponding imaging apparatus and a corresponding inspection system.

### Application Example

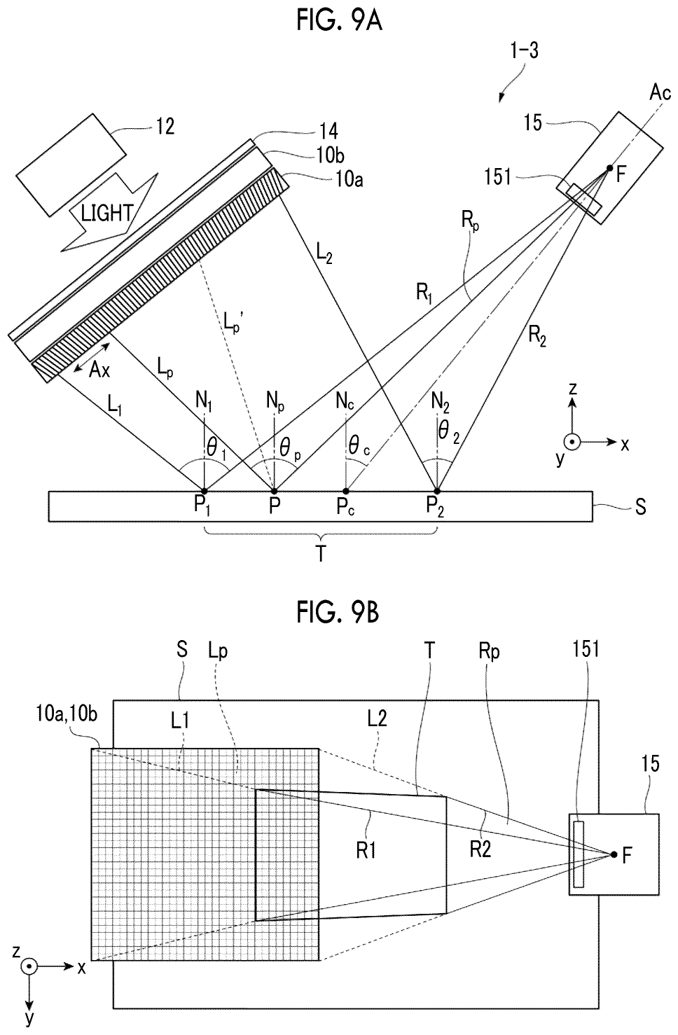

FIGS. 9A and 9B are diagrams illustrating an inspection apparatus 1-3 of an application example, FIG. 9A is a diagram schematically showing the internal structure of the inspection apparatus 1-3, and FIG. 9B is a diagram of FIG. 9A viewed from an upper side of a plane of paper (+z direction). Components identical to the components of the inspection apparatus 1 which is shown in FIGS. 2A and 2B and to which the first exemplary embodiment is applied may be denoted by reference numerals identical to the reference numerals of the components of the inspection apparatus 1, and the description thereof may be omitted. Further, some components are not shown as in FIGS. 2A and 2B.

As shown in FIG. 9A, the inspection apparatus 1-3 of the application example includes not only a light blocking wall group 10a that is identical to the light blocking wall group 10 but also a light blocking wall group 10b that is provided between the light blocking wall group 10a and the diffusion plate 14. Further, the light blocking wall group 10b is formed of light blocking walls that are arranged in a direction (a y direction in FIG. 9A) intersecting with the direction Ax.

Since the inspection apparatus 1 to which the first exemplary embodiment is applied includes the light blocking wall group 10 that is formed of the light blocking walls 101 arranged in the direction Ax as described above with reference to FIGS. 2A and 2B and FIG. 3, pieces of specularly reflected light Rp reflected from the respective points P arranged in the x direction in the target region T intersect at the intersection F.

Since the inspection apparatus 1-3 of the application example includes the light blocking wall group 10b in addition to the light blocking wall group 10a as shown in FIG. 9B, pieces of specularly reflected light Rp reflected from the respective points P arranged not only in the x direction but also in the y direction intersect at the intersection F. As a result, in the inspection apparatus 1-3 of the application example, reflected light, which is reflected from the target region T and reaches the camera 15, is concentrated in a range that is narrower than the target region T in the x direction and the y direction.

In addition, in the inspection apparatus 1-3 of the application example, diffusion components are suppressed not only in the x direction but also in the y direction of the target region T. Accordingly, since a defect is easily observed regardless of a direction in which a defect extends, it may be possible to contribute to the improvement of the accuracy of inspection.

The light blocking wall group 10a is provided close to the target region T and the light blocking wall group 10b is provided close to the light source 12 in the example shown in FIGS. 9A and 9B. However, the positions of the light blocking wall group 10a and the light blocking wall group 10b may be exchanged with each other.

Further, the application example corresponding to the first exemplary embodiment has been described in FIGS. 9A and 9B, but an application example corresponding to the second exemplary embodiment is also conceivable. That is, the inspection apparatus 1-3 of the application example may be adapted to use two limiting layers described above. In this case, a thick limiting layer may be used or a limiting layer formed of a film may be used.

### Other Modification Examples and The Like

Although the exemplary embodiments of the present invention have been described above, a technical scope of the present invention is not limited to the scope described in the above-mentioned exemplary embodiments. It is apparent from claims that exemplary embodiments in which various modifications or improvements are added to the above-mentioned exemplary embodiments are also included in the technical scope of the present invention.

A white light source has been used as the light source 12 (see FIGS. 1A and 1B) in the above-mentioned exemplary embodiments, but the color of the light source may be any color. Further, light emitted from the light source is not limited to light having a wavelength range of visible light, and the light source may emit light having a wavelength range of infrared light or light having a wavelength range of ultraviolet light.

Furthermore, the inspection apparatus 1 using one light source 12 has been described, but may use a plurality of light sources.

In addition, the present invention is not limited to an exemplary embodiment in which the inspection apparatus 1 includes the light source. For example, openings or light transmission ports may be provided at the position of the light source 12 shown in FIGS. 1A and 1B, and light emitted from an external light source may be used through these openings or light transmission ports.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above-mentioned exemplary embodiments, the processor 13a of the inspection apparatus 1 acquires an inspection image and performs low-pass filtering and generates an inspection result. However, the inspection image may be transmitted to another device, and the device that is a destination of transmission may perform low-pass filtering and generate an inspection result. In this case, the inspection apparatus 1 and the device that is a destination of transmission form an inspection system.

Supplementary Note

(((1)))

An inspection apparatus comprising:

a limiting unit that is provided between a light source and a target region and limits light traveling from the light source toward the target region; and

an imaging unit that captures an image using light passing through the limiting unit, reflected from the target region, and incident on the imaging unit,

wherein the limiting unit allows light, which travels in one direction and is incident on the imaging unit in a case where the light is specularly reflected from the target region, to pass and allows at least a part of light, which travels in other directions, not to pass, among light emitted from the light source.

(((2)))

The inspection apparatus according to (((1))),

wherein the limiting unit allows at least a part of light, which travels in a direction approaching the imaging unit, among the light traveling in other directions not to pass.

(((3)))

The inspection apparatus according to (((1))) or (((2))),

wherein the limiting unit allows light, which forms an angle of 20° or more with the light traveling in the one direction, among the light traveling in other directions not to pass.

(((4)))

The inspection apparatus according to any one of (((1))) to (((3))),

wherein the limiting unit sets an amount of light, which travels in other directions and is allowed to pass, to 50% or less of an amount of light traveling in the one direction.

(((5)))

The inspection apparatus according to any one of (((1))) to (((4))),

wherein the limiting unit is a group of light blocking walls that are arranged in a direction intersecting with the one direction and are not parallel to each other.

(((6)))

The inspection apparatus according to any one of (((1))) to (((5))),

wherein an interval at which the light blocking walls are arranged is 1.5 mm or less.

(((7)))

The inspection apparatus according to (((1))),

wherein the limiting unit is formed of a limiting layer in which portions transmitting light emitted from the light source and portions not transmitting the light emitted from the light source are alternately arranged.

(((8)))

The inspection apparatus according to (((7))),

wherein the limiting layer is formed of a film, and is disposed to be bent such that the portions transmitting the light emitted from the light source are orthogonal to the one direction.

(((9)))

The inspection apparatus according to (((7))) or (((8))),

wherein the limiting unit is formed of a plurality of limiting layers that are arranged in a direction intersecting with the one direction.

(((10)))

An Inspection System Comprising:

a limiting unit that is provided between a light source and a target region and limits light traveling from the light source toward the target region;

an imaging unit that captures an image using light passing through the limiting unit, reflected from the target region, and incident on the imaging unit; and

a processor that is configured to process the image captured by the imaging unit,

wherein the limiting unit allows light, which travels in one direction and is incident on the imaging unit in a case where the light is specularly reflected from the target region, to pass and allows at least a part of light, which travels in other directions, not to pass, among light emitted from the light source.

(((11)))

The inspection system according to (((10))),

wherein the limiting unit is provided with openings that allow the light traveling in the one direction to pass and are arranged at predetermined intervals, and

the processor is configured to perform processing of removing components equal to or higher than a frequency corresponding to the predetermined intervals, on the image captured by the imaging unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An inspection apparatus comprising:
a limiting unit that is provided between a light source and a target region and limits light traveling from the light source toward the target region; and
an imaging unit that captures an image using light passing through the limiting unit, reflected from the target region, and incident on the imaging unit,
wherein the limiting unit allows light, which travels in one direction and is incident on the imaging unit in a case where the light is specularly reflected from the target region, to pass and allows at least a part of light, which travels in other directions, not to pass, among light emitted from the light source.

2. The inspection apparatus according to claim 1,
wherein the limiting unit allows at least a part of light, which travels in a direction approaching the imaging unit, among the light traveling in other directions not to pass.

3. The inspection apparatus according to claim 2,
wherein the limiting unit allows light, which forms an angle of 20° or more with the light traveling in the one direction, among the light traveling in other directions not to pass.

4. The inspection apparatus according to claim 2,
wherein the limiting unit sets an amount of light, which travels in other directions and is allowed to pass, to 50% or less of an amount of light traveling in one direction.

5. The inspection apparatus according to claim 1,
wherein the limiting unit is a group of light blocking walls that are arranged in a direction intersecting with the one direction and are not parallel to each other.

6. The inspection apparatus according to claim 5,
wherein an interval at which the light blocking walls are arranged is 1.5 mm or less.

7. The inspection apparatus according to claim 1,
wherein the limiting unit is formed of a limiting layer in which portions transmitting light emitted from the light source and portions not transmitting the light emitted from the light source are alternately arranged.

8. The inspection apparatus according to claim 7,
wherein the limiting layer is formed of a film, and is disposed to be bent such that the portions transmitting the light emitted from the light source are orthogonal to the one direction.

9. The inspection apparatus according to claim 7,
wherein the limiting unit is formed of a plurality of limiting layers that are arranged in a direction intersecting with the one direction.

10. An inspection system comprising:
a limiting unit that is provided between a light source and a target region and limits light traveling from the light source toward the target region;
an imaging unit that captures an image using light passing through the limiting unit, reflected from the target region, and incident on the imaging unit; and
a processor that is configured to process the image captured by the imaging unit,
wherein the limiting unit allows light, which travels in one direction and is incident on the imaging unit in a case where the light is specularly reflected from the target region, to pass and allows at least a part of light, which travels in other directions, not to pass, among light emitted from the light source.

11. The inspection system according to claim 10,
wherein the limiting unit is provided with openings that allow the light traveling in the one direction to pass and are arranged at predetermined intervals, and
the processor is configured to perform processing of removing components equal to or higher than a frequency corresponding to the predetermined intervals, on the image captured by the imaging unit.

12. An inspection apparatus comprising:
limiting means provided between a light source and a target region and for limiting light traveling from the light source toward the target region; and
imaging means for capturing an image using light passing through the limiting means, reflected from the target region, and incident on the imaging means,
wherein the limiting means allows light, which travels in one direction and is incident on the imaging means in a case where the light is specularly reflected from the target region, to pass and allows at least a part of light, which travels in other directions, not to pass, among light emitted from the light source.
